(19) United States
(12) Patent Application Publication
(10) Pub. No.: US 2010/0171776 A1
(43) Pub. Date: Jul. 8, 2010

(54) PICTURE DISPLAY DEVICE

(75) Inventors: Takatugu Yamagata, Hokkaido (JP); Hideki Abe, Hokkaido (JP); Kosho Suzuki, Hokkaido (JP); Kouji Terawaki, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/299,527

(22) PCT Filed: Jun. 13, 2008
(86) PCT No.: PCT/JP2008/001524

§ 371 Date: Nov. 4, 2008

(30) Foreign Application Priority Data
Jun. 18, 2007 (JP) 2007-159790

(51) Int. Cl. G09G 5/10

(52) U.S. Cl. 345/691

(57) ABSTRACT

A picture display device including a picture display section for projecting an input picture signal; a light source for visualizing a picture in the picture display section; a moving picture detecting section for outputting a scanning line movement determination signal for every scanning line based on a movement amount of a picture signal for every scanning line; a PWM pulse generating section for controlling flashing of the light source; and a PWM control section for outputting a moving image specifying signal that specifies a moving image area included in a frame based on the scanning line movement determination signal to control the PWM pulse generating section. The PWM control section controls the PWM pulse generating section in a blinking mode by turning off the light source in a period for scanning the moving image area including a scanning line having a largest movement amount.

This application is a U.S. National Phase Application of PCT International Application PCT/JP2008/001524.

### TECHNICAL FIELD

The present invention relates to a picture display device having a light source such as a backlight, which is used in picture equipment such as a liquid crystal television and a projector.

### BACKGROUND ART

A CRT (cathode ray tube) is an impulse type display device in which light is momentarily emitted from a phosphor for every field and nothing is displayed until a next display is carried out. Even in an impulse type display device, human can see a moving picture as a smooth image without feeling an after image. On the other hand, a liquid crystal display device addresses display data in pixels arranged in a matrix once per frame by using a data signal line and a scan signal line. Then, the addressed display data are held for one frame period. That is to say, a liquid crystal display device is a so-called hold type display device that keeps displaying the same picture in one frame. Such a hold type display element displays an image existing in a correct position in a moment in one frame. In another time, however, the display element displays an image existing in a place different from a position in which an image really exists at the time. Human sees such images by averaging them, so that images appear blurred. As a result, it is difficult to dissolve blur in a moving picture regardless of the response speed of liquid crystal.

As one of methods for resolving this problem, the following liquid crystal display device is used. FIG. 12 is a block diagram showing a configuration of a conventional liquid crystal display device (see, for example, Patent Document 1). A conventional liquid crystal display device includes at least comparator circuit 106, comparison result memory circuit 107, and backlight waveform control circuit (hereinafter, abbreviated as “BL waveform control circuit”) 108.

Hereinafter, an operation of a conventional liquid crystal display device is described. The thus configured liquid crystal display device divides a display area of liquid crystal panel 101 into a plurality of blocks and detects the presence or absence of a moving picture for every block in an image to be input into liquid crystal panel 101 in one vertical cycle period by using comparator circuit 106, comparison result memory circuit 107 and BL waveform control circuit 108. BL waveform control circuit 108 makes display into an impulse type by adjusting the waveform and phase of a drive voltage of backlight 110 in one vertical cycle period in response to a state in which a block including a moving picture appears in one vertical cycle period.

That is to say, the waveform and phase of a drive voltage of backlight 110 are adjusted for every block including a moving picture. As a result, for example, when a moving picture exists in a part of an image for one vertical cycle period, the moving picture in a block including a moving picture can be displayed with high quality.

However, in a conventional liquid crystal display device, since a turning-off period is fixed for every block, the size of the subject moving picture is limited by the size of the block.

[Patent document 1] Japanese Patent Application Unexamined Publication No. 2004-309592

### SUMMARY OF THE INVENTION

A picture display device of the present invention includes a picture display section for projecting an input picture signal; a light source for visualizing a picture in the picture display section; a moving picture detecting section for outputting a scanning line movement determination signal for every scanning line based on a movement amount of a picture signal for every scanning line; a PWM pulse generating section for controlling flashing of the light source; and a PWM control section for outputting a moving image specifying signal that specifies a moving image area included in a frame based on the scanning line movement determination signal, to control the PWM pulse generating section. The PWM control section controls the PWM pulse generating section in a blinking mode by turning off the light source in a period for scanning the moving image area including the scanning line having a largest movement amount.

With such a configuration, the detected moving image is allowed to be not displayed in a data addressing period by turning off the light source for a predetermined time from a start scanning line of panel scanning, thereby allowing display to approach to impulse type display. Thus, it is possible to improve the quality of the moving picture.

### BRIEF DESCRIPTION OF THE DRAWINGS

FIG. 1 is a block diagram showing a configuration of a picture display device in accordance with a first exemplary embodiment of the present invention.

FIG. 2A is a conceptual diagram showing a screen of a picture display section to illustrate an operation of a PWM control section of the picture display device.

FIG. 2B is a conceptual diagram to illustrate an operation in which the PWM control section of the picture display device specifies scanning line groups including moving image areas.

FIG. 3 is a view to illustrate a detailed operation of a moving picture detecting section of the picture display device.

FIG. 4 is a view showing one example of a moving image specifying signal output by the PWM control section of the picture display device.

FIG. 5 is a block diagram showing a configuration of a picture display device in accordance with another example of the first exemplary embodiment.

FIG. 6A is a conceptual diagram showing an N frame to illustrate an operation of the picture display device.

FIG. 6B is a conceptual diagram showing an (N+4) frame to illustrate an operation of the picture display device.

FIG. 6C is a conceptual diagram showing an (N+8) frame to illustrate an operation of the picture display device.

FIG. 6D is a conceptual diagram showing an N frame to illustrate an operation of the picture display device.

FIG. 6E is a conceptual diagram showing an (N+4) frame to illustrate an operation of the picture display device.

FIG. 6F is a conceptual diagram showing an (N+8) frame to illustrate an operation of the picture display device.

FIG. 7 is a conceptual diagram to illustrate a PWM control waveform of the picture display device.

FIG. 8 is a conceptual diagram to illustrate a case in which the PWM control section of the picture display device switches a control operation between a normal image mode and a blinking mode.

FIG. 9 is a block diagram showing a configuration of a picture display device in accordance with a further example of the first exemplary embodiment.

FIG. 10 is a block diagram showing a configuration of a picture display device in accordance with a second exemplary embodiment of the present invention.

FIG. 11 is a block diagram showing a configuration of a picture display device in accordance with a third exemplary embodiment of the present invention.

FIG. 12 is a block diagram showing a configuration of a conventional picture display device.

### REFERENCE MARKS IN THE DRAWINGS

10 picture display section
11 light source
12 moving picture detecting section
13 characteristic amount detecting section
14 light source luminance setting section
15 PWM control section
16 PWM pulse generating section
17 outside light detecting section
18 user luminance setting input section
19 high-luminance moving picture detecting section
20 moving image area
21 moving image area
22 movement amount
23 lower-limit movement determination threshold value
24 start scanning line
25 end scanning line
26 start scanning line
27 end scanning line
28 scanning line group
29 scanning line group
30 maximum movement scanning line
51 moving image area
52 moving image area
53 moving image area
54 turning-off period
55 turning-off period
56 turning-off period
60 turning-off period
65 turning-off period
66 turning-off period
81 start scanning line
82 start scanning line
83 start scanning line
84 end scanning line
85 end scanning line
86 end scanning line

### DETAILED DESCRIPTION OF THE PREFERRED EMBODIMENTS

Hereinafter, exemplary embodiments of the present invention are described with reference to drawings.

### First Exemplary Embodiment

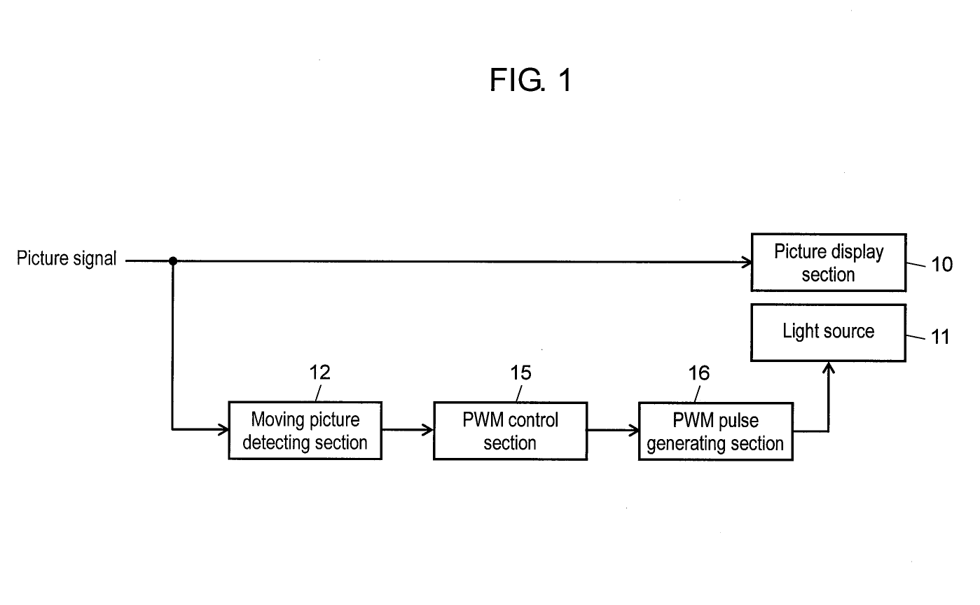

FIG. 1 is a block diagram showing a configuration of a picture display device in accordance with a first exemplary embodiment of the present invention. As shown in FIG. 1, the picture display device includes picture display section 10, light source 11, moving picture detecting section 12, PWM control section 15, and PWM pulse generating section 16 for controlling flashing of light source 11. Next, an operation of the thus configured picture display device is described.

Picture display section 10 projects an input picture signal. Furthermore, light source 11 visualizes a picture in picture display section 10.

Moving picture detecting section 12 outputs a scanning line movement determination signal for every scanning line based on a movement amount for every scanning line of the picture signal. For example, moving picture detecting section 12 compares a picture signal in the present frame of a certain scanning line with a picture signal in one precedent frame of the same scanning line in a unit of a pixel. Then, a value obtained by cumulatively adding the difference for only one scanning period is defined as a movement amount of the picture signal for every scanning line. Moving picture detecting section 12 judges that a moving image exists when the movement amount for every scanning line exceeds a movement determination threshold value, and judges that a moving image does not exist when the movement amount does not exceed the movement determination threshold value. Based on the result, moving picture detecting section 12 outputs a scanning line movement determination signal for every scanning line.

Furthermore, the movement amount of a picture signal for every scanning line may be detected by, for example, the following method: firstly, the input picture signal is allowed to pass through a high-pass filter so as to detect an edge included in the N-th scanning line (N corresponds to an arbitrary position in the frame) of a frame constituting the picture signal; then, a shift amount of the edge with respect to an edge in a frame preceding to the above-mentioned frame in the N-th scanning line is detected. Various techniques can be applied for detecting an edge of the moving image. The technique is not necessarily limited to this example.

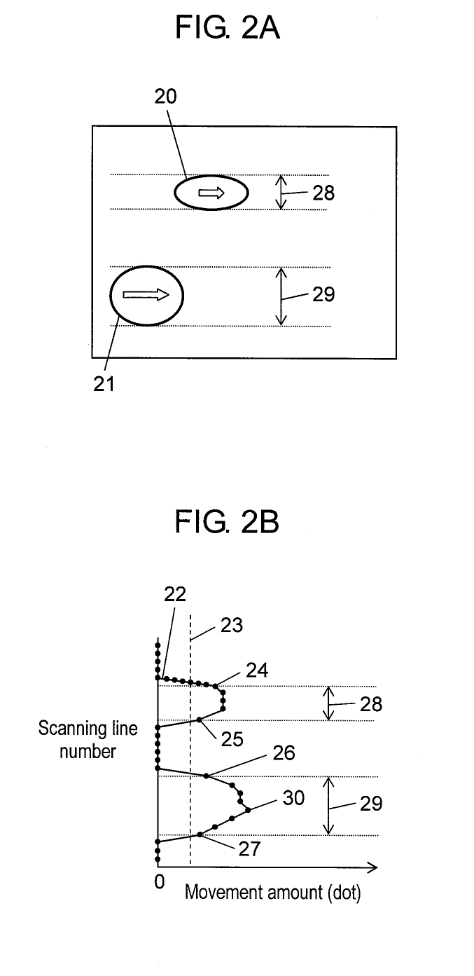

Next, a detail of an operation of moving picture detecting section 12 is described with reference to FIGS. 2A and 2B. FIG. 2A is a conceptual diagram of a screen of picture display section 10 to illustrate an operation of moving picture detecting section 12. FIG. 2B is a conceptual diagram to illustrate an operation in which PWM control section 15 specifies scanning line groups 28 and 29 including moving image areas 20 and 21.

As shown in FIG. 2A, for example, moving image areas 20 and 21 are assumed to exist on the screen of picture display section 10. The movement amount of moving image area 20 is assumed to be smaller than that of moving image are 21. Furthermore, in this example, both moving image areas 20 and 21 are assumed to shift in the direction parallel to the scanning line as shown by arrows in the drawing.

FIG. 2B, in the abscissa, shows movement amount 22 for every scanning line of the picture signal in the image shown in FIG. 2A. Meanwhile, the ordinate corresponds to the numbers (positions on the screen) of the respective scanning lines. FIG. 2B shows movement amount 22 (shift amount) in the direction parallel to the scanning lines in moving image areas 20 and 21 by the number of dots. The drawings are conceptual diagrams and do not show movement amount 22 of all scanning lines.

Movement amount 22 shown in FIG. 2B shows a shift amount between the edge of the precedent frame and the edge of the currently displayed frame by the number of dots on the screen. Lower-limit movement determination threshold value 23 is assumed to be, for example, not less than two dots and an upper-limit movement determination threshold value (not shown) is assumed to be, for example, not more than 20 dots. That is to say, moving picture detecting section 12 judges that a moving image exists when the shift amount of the edge, that is, the movement amount for every scanning line is not less than lower-limit movement determination threshold value (for example, two dots) 23 and not more than the upper-limit movement determination threshold value (for example, 20 dots) (not shown). Based on the result, moving picture detecting section 12 outputs a scanning line movement determination signal for every scanning line. On the other hand, moving picture detecting section 12 judges that a moving image does not exist and does not specify the moving image area, when the shift amount of the edge, that is, the movement amount for every scanning line is less than lower-limit movement determination threshold value (for example, two dots) 23, or more than the upper-limit movement determination threshold value (for example, 20 dots) (not shown). Based on the result, moving picture detecting section 12 outputs a scanning line movement determination signal for every scanning line. However, this movement determination threshold value is not necessarily limited to this value and may be selected appropriately from the characteristics of the picture display device.

As shown in FIG. 2B, since the screen is in a state of a still image in a part corresponding to the upper part of the screen, movement amount 22 is 0 dots. In scanning line group 28 corresponding to moving image area 20, which is defined by start scanning line 24 and end scanning line 25, movement amount 22 is not less than lower-limit movement determination threshold value 23. Similarly, in scanning line group 29 corresponding to moving image area 21, which is defined by start scanning line 26 and end scanning line 27, movement amount 22 is not less than lower-limit movement determination threshold value 23. Furthermore, movement amount 22 is largest in maximum movement scanning line 30. Herein, both scanning line groups 28 and 29 are not assumed to exceed the upper-limit movement determination threshold value (not shown). That is to say, moving picture detecting section 12 outputs a signal, as a scanning line movement determination signal, showing that a moving picture is included in a scanning line period in the scanning line included in moving image areas 20 and moving image area 21. PWM control section 15 can specify moving image areas 20 and 21 of FIG. 2A by scanning lines 28 and 29 of FIG. 2B based on the scanning line movement determination signal.

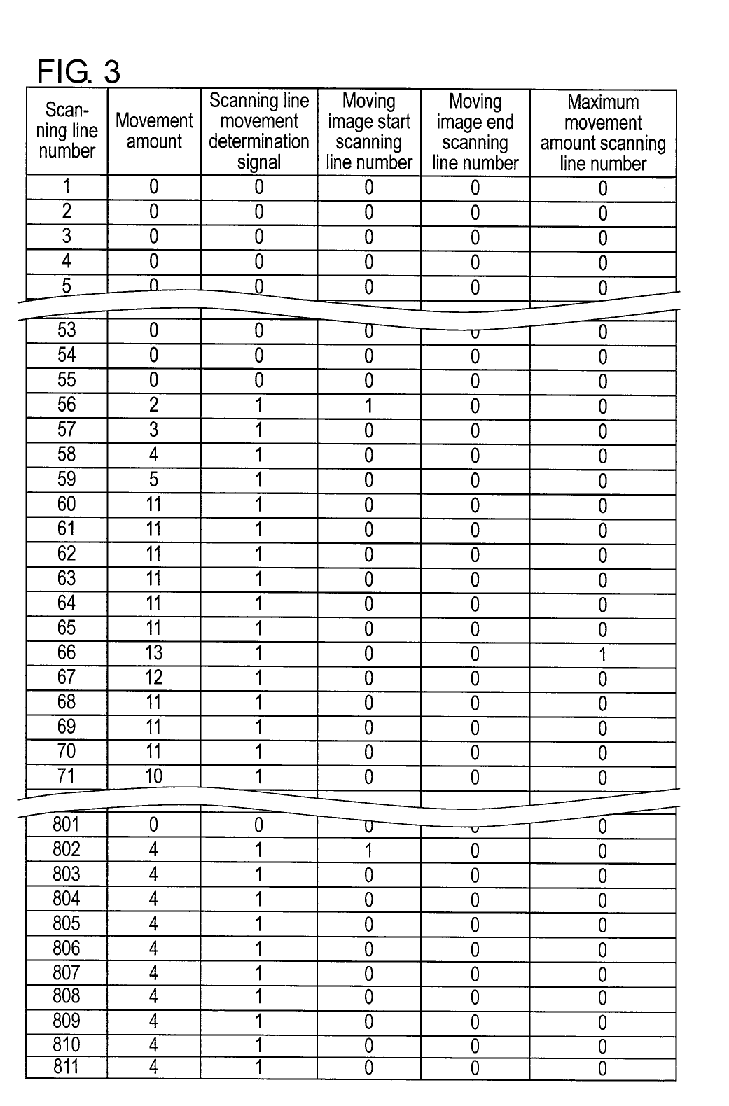

Herein, a further detailed operation of moving picture detecting section 12 is described with reference to FIG. 3. FIG. 3 shows a scanning line number output from moving picture detecting section 12, a movement amount, a scanning line movement determination signal, a moving image start scanning line number, a moving image end scanning line number, and a maximum movement amount scanning line number. The scanning line carries out scanning more largely sequentially from the scanning line number “1.” Moving picture detecting section 12 detects a movement amount for every scanning line. For example, in the scanning line number “1” shown at the top of the screen, the movement amount is “0.” Therefore, a scanning line movement determination signal becomes “0.” That is to say, the scanning line movement determination signal outputs “1” when the movement amount is not less than lower-limit movement determination threshold value 23 and not more than the upper-limit movement determination threshold value and outputs “0” in other case.

The moving image start scanning line number and the moving image end scanning line number can be easily obtained from the scanning line movement determination signal. That is to say, the moving image start scanning line number outputs “1” only when the scanning line movement determination signal becomes “1” from “0,” and outputs “0” in other case. In FIG. 3, the scanning line number No. 56 corresponds to this example. The moving image end scanning line number outputs “1” (not shown) only when the scanning line movement determination signal becomes to “0” from “1,” and outputs “0” in other case. The scanning line number between the moving image start scanning line number and the moving image end scanning line number shows a moving image area.

Furthermore, moving picture detecting section 12 outputs “1,” as a maximum movement amount scanning line number, to the scanning line having the largest movement amount in the movement amount included in the moving image area. In FIG. 3, the scanning line number No. 66 corresponds to this example. Then, moving picture detecting section 12 outputs “0” in other case. Therefore, it is possible to easily detect a moving image area in which the maximum movement amount scanning line number is “1.”

Note here that an example of FIG. 3 shows that moving picture detecting section 12 can specify a moving image area by outputting a scanning line movement determination signal, a moving image start scanning line number, a moving image end scanning line number, and a maximum movement amount scanning line number from the movement amount. However, when moving picture detecting section 12 is assumed to output a scanning line number, a movement amount, a scanning line movement determination signal and a maximum movement amount scanning line number, a moving image area can be specified easily. Therefore, the scanning line movement determination signal including the maximum movement amount scanning line number, which is multiplexed in a time-sharing manner, may be output. Thus, it is possible to transmit necessary information while the number of scanning lines is reduced.

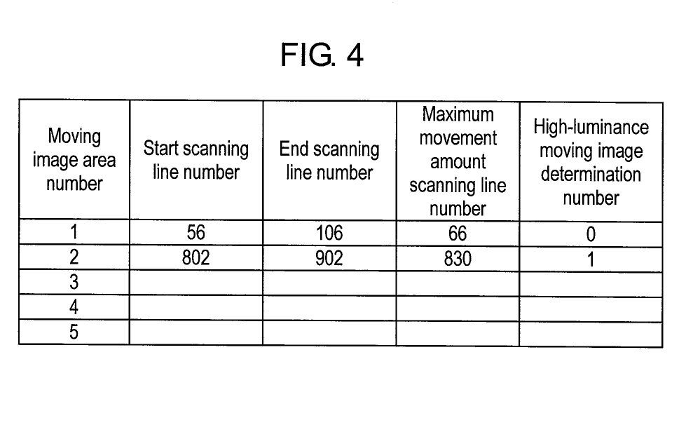

Then, PWM control section 15 specifies a moving image area included in a frame based on a scanning line movement determination signal output from moving picture detecting section 12 and outputs a moving image specifying signal. FIG. 4 is a view showing an example of a moving image specifying signal output by PWM control section 15. As shown in FIG. 4, in order to specify the moving image area on the screen, PWM control section 15 outputs a moving image area number, a moving image start scanning line number, a moving image end scanning line number, a maximum movement amount scanning line number, and a high-luminance moving image determination signal, as the moving image specification signal. The moving image area number (herein, No. 1) showing the first moving image area is related to the moving image start scanning line number (herein, No. 56), the moving image end scanning line number (herein, No. 106), the maximum movement amount scanning line number (herein, No. 66), and the high-luminance moving image determination signal (herein, 0). The second moving image area can be also specified on the screen from these numbers. Note here that the high-luminance moving image determination signal is a signal that determines whether or not the moving image area is a high-luminance moving image. The detailed description is mentioned later.

Then, when a moving image specifying signal is output, PWM control section 15 outputs a signal so that light source 11 is turned off in a period for scanning a moving image area including a scanning line having the largest movement amount, and controls PWM pulse generating section 16 in a blinking mode. That is to say, PWM control section 15 controls PWM pulse generating section 16 so that light source 11 is turned off based on a moving image start scanning line number, a moving image end scanning line number, and a maximum movement amount scanning line number. Furthermore, PWM control section 15 may control PWM pulse generating section 16 in a blinking mode so that the luminance of the light source becomes a reference value by further turning off an area other than the moving image area. Herein a blinking mode refers to making display into an impulse type, detail of which is mentioned below.

Furthermore, when a moving image specifying signal is not output, PWM control section 15 may control PWM pulse generating section 16 in a normal image mode. Herein, the normal image mode is a mode in which normal image display is carried out without making display into an impulse type. Then, this normal image mode may include driving at a vertical driving rate that are a constant rate, a double rate, or at a higher rate than the rate.

Thus, PWM control section 15 specifies a moving image area based on the scanning line movement determination signal and controls PWM pulse generating section 16 in a blinking mode when the movement amount for every scanning line is not less than the lower-limit movement determination threshold value and not more than the upper-limit movement determination threshold value. Furthermore, PWM control section 15 does not specify a moving image area based on the scanning line movement determination signal and controls PWM pulse generating section 16 in a normal image mode when the movement amount for every scanning line is less than the lower-limit threshold value or more than the upper-limit threshold value.

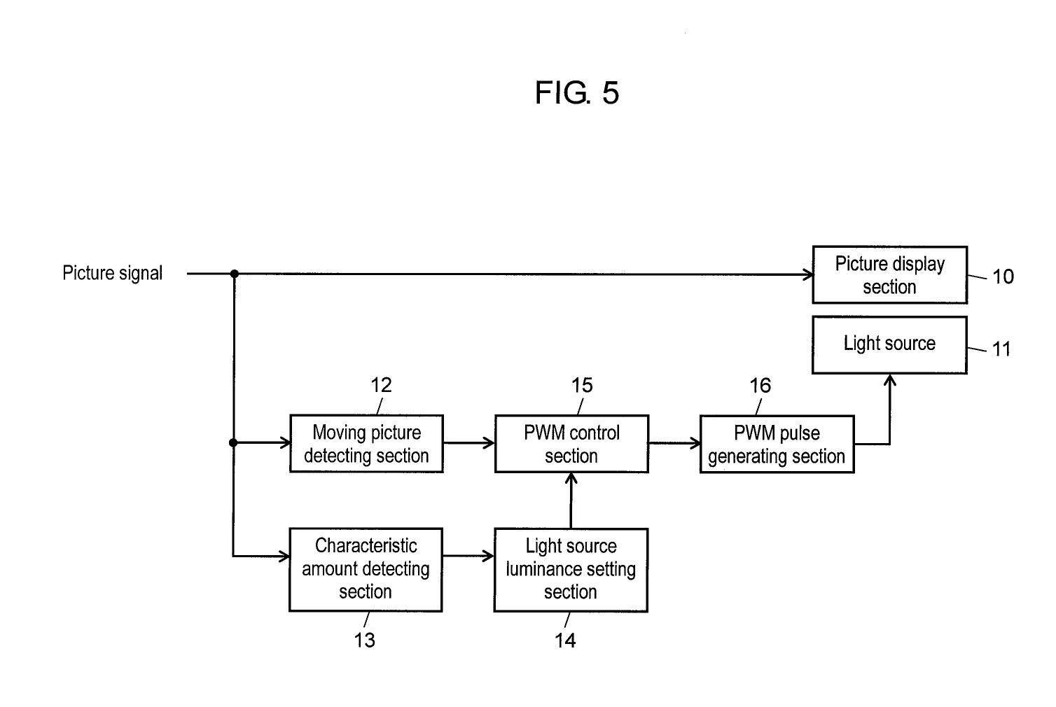

FIG. 5 is a block diagram showing a configuration of a picture display device in accordance with another example of the present exemplary embodiment. The picture display device of the other example is different from that of the above-mentioned example of the present exemplary embodiment in that it further includes characteristic amount detecting section 13 and light source luminance setting section 14. Since picture display device of the other example has the same configuration and the same operation as in the above-mentioned example of the present exemplary embodiment except that characteristic amount detecting section 13 and light source luminance setting section 14 are further provided, detailed description is omitted.

Characteristic amount detecting section 13 detects the average luminance value of the input picture signal. Then, characteristic amount detecting section 13 outputs the detected average value to light source luminance setting section 14.

Light source luminance setting section 14 determines the reference value of the luminance of the light source. Specifically, light source luminance setting section 14 determines the reference value of the luminance of the light source based on the average luminance value detected by characteristic amount detecting section 13. That is to say, in response to the output of characteristic amount detecting section 13, the reference value of the luminance of the light source is determined so that the luminance of the light source is set to be high when the average luminance value is high, and set to be low when the average luminance value is low. Light source luminance setting section 14 outputs the reference value of the luminance of the light source to PWM control section 15 as a signal for controlling PWM control section 15.

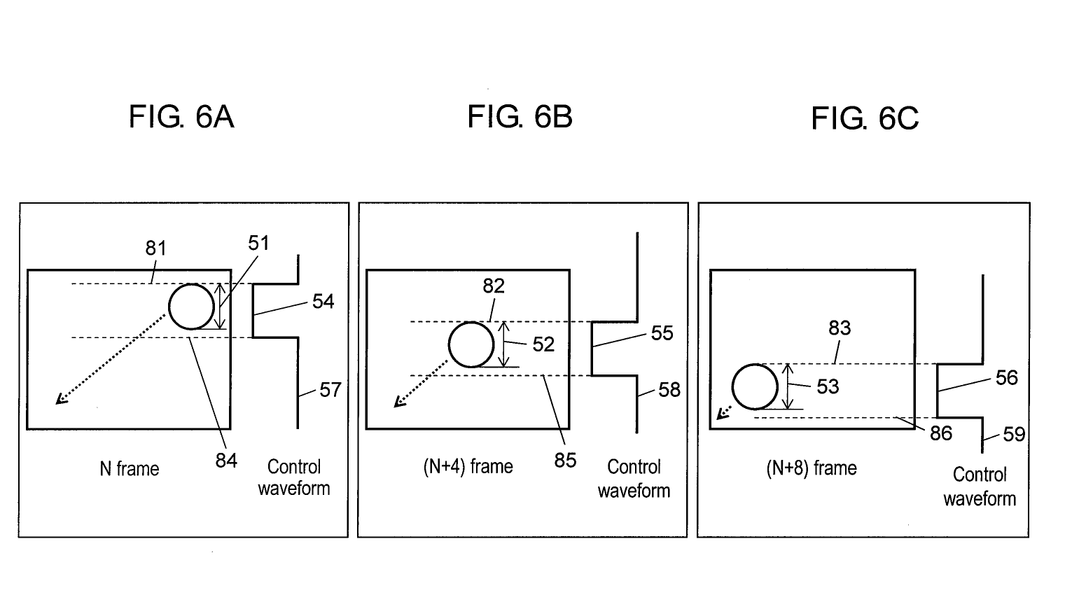

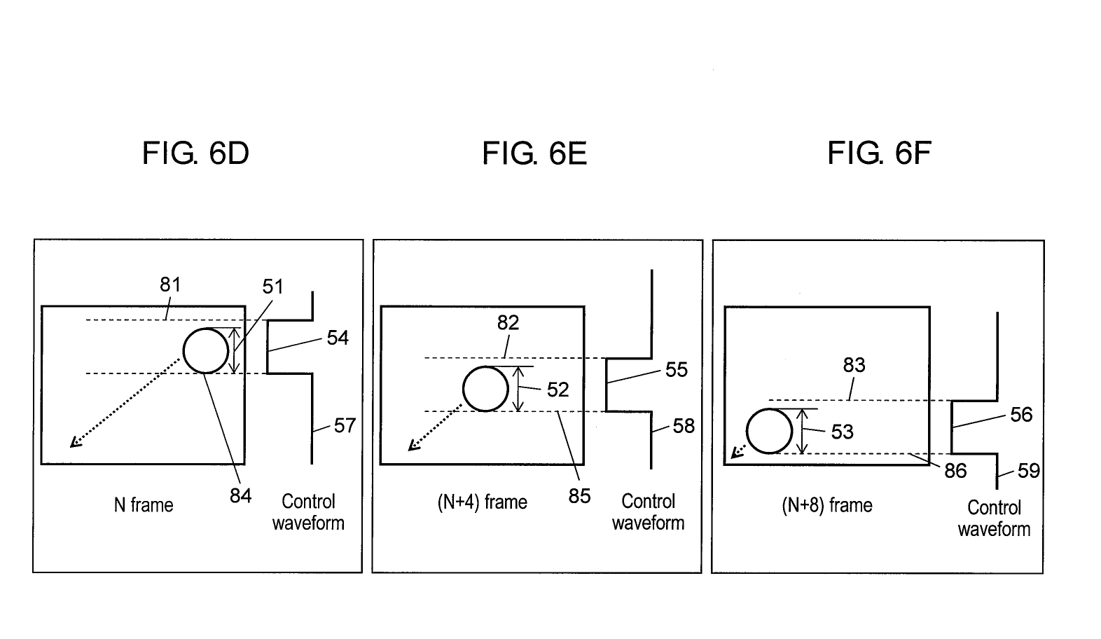

Herein, an operation of the display device of the other example in accordance with the first exemplary embodiment is described with reference to FIGS. 6A, 6B, 6C, 6D, 6E and 6F. FIGS. 6A, 6B, 6C, 6D, 6E and 6F are conceptual diagrams to illustrate an operation of the picture display device of the other example in accordance with the first exemplary embodiment, respectively.

As shown in the drawings, FIGS. 6A, 6B, and 6C show an N frame, an (N+4) frame and an (N+8) frame (herein, N is an integer), respectively. Furthermore, control waveforms of turning-on and turning-off of light source 11 in the respective frames are shown. The difference in these frames is that moving image area 51, 52 and 53 shift from the upper right portion toward the lower left portion in the screen. Furthermore, the scanning line numbers when light source 11 is turned on and off are accordingly changed.

As mentioned above, light source luminance setting section 14 may determine the reference value of the luminance of the light source based on the average luminance value in response to the output from characteristic amount detecting section 13. In this case, from the screen luminance, turning-off periods 54, 55 and 56 of light source 11 when the moving picture is included are determined. Herein, for example, light source 11 is turned on in 70% of one vertical synchronization period and off in 30% thereof. Furthermore, as mentioned above, moving picture detecting section 12 outputs a scanning line movement determination signal for every scanning line based on the movement amount for every scanning line of a picture signal. Then, as shown in FIG. 6A, based on the scanning line movement determination signal, PWM control section 15 controls PWM pulse generating section 16 so that light source 11 is turned off from start scanning line 81 in which a panel scans an area corresponding to a start scanning line (vertical position) of moving image area 51. Furthermore, turning-off period 54 is determined so that a predetermined luminance of the light source is obtained based on the average luminance value. That is to say, in this case, for example, light source 11 is turned on in end scanning line 84 corresponding to 30% of the vertical synchronization period. Note here that 30% of the vertical synchronization period is based on the reference value of the luminance of the light source and is not necessarily limited to this value.

Next, control of PWM control section 15 in the (N+4) frame shown in FIG. 6B is described. Moving image area 51 shown in FIG. 6A shifts toward the position of moving image area 52 in the (N+4) frame. PWM control section 15 controls PWM pulse generating section 16 so that light source 11 is turned off from start scanning line 82 in which a panel scans a start scanning line of moving image area 52 based on the scanning line movement determination signal. Furthermore, turning-off period 55 is determined so that the reference value of the luminance of the light source can be obtained based on the average luminance value. That is to say, in this case, for example, light source 11 is turned on in end scanning line 85 corresponding to 35% of the vertical synchronization period. Note here that 35% of the vertical synchronization period is based on the reference value of the luminance of the light source and is not necessarily limited to this value.

Next, control of PWM control section 15 in the (N+8) frame shown in FIG. 6C is described. Moving image area 52 shown in FIG. 6B shifts toward the position of moving image area 53 in the (N+8) frame. PWM control section 15 controls PWM pulse generating section 16 so that light source 11 is turned off from start scanning line 83 in which a panel scans a start scanning line of moving image area 53 based on the scanning line movement determination signal. Furthermore, turning-off period 56 is determined so that the reference value of the luminance of the light source can be obtained based on the average luminance value. That is to say, in this case, for example, light source 11 is turned on in end scanning line 86 corresponding to 33% of the vertical synchronization period. Note here that 33% of the vertical synchronization period is based on the reference value of the luminance of the light source and is not necessarily limited to this value.

In the above-mentioned FIGS. 6A, 6B and 6C, PWM pulse generating section 16 is assumed to be controlled so that light source 11 is turned off from start scanning lines 81, 82 and 83 in which a panel scans start scanning lines of moving image areas 51, 52 and 53, respectively. However, as shown in FIGS. 6D, 6E, and 6F, PWM pulse generating section 16 may be controlled so that light source 11 is turned on from end scanning lines 84, 85, and 86 in which a panel scans the end scanning lines of moving image areas 51, 52 and 53, and start scanning lines 81, 82 and 83 may be determined so that the reference value of the luminance of the light source can be obtained in turning-off periods 54, 55 and 56 of light source 11.

That is to say, PWM pulse generating section 16 is controlled in a blinking mode so that the luminance of the light source becomes the reference value by turning off light source 11 in a period for scanning moving image areas 51, 52 and 53 including a scanning line with the largest movement amount and by further turning off the other area than moving image areas 51, 52 and 53. Herein, the above-mentioned other area is an area that continues to moving image areas 51, 52 and 53.

The turning-off timing of light source 11 is allowed to coincide with the timing at which a signal is addressed into a scanning line included in moving image areas 51, 52 and 53. Thus, the changing picture during readdressing of moving image data is not displayed. An image before readdressing and a picture after readdressing are displayed separately. Furthermore, during this time, by the effect of inserting black by turning off light source 11, hold type display approaches to impulse type display. Thus, blur in a moving picture is suppressed and the quality of the moving picture can be improved. When moving image areas 51, 52 and 53 are shifted in the upper and lower directions of the screen, turning-off periods 54, 55 and 56 are allowed to follow moving image areas 51, 52 and 53. Therefore, it is possible to improve the quality of the moving picture by suppressing blur in a moving picture in response to not only the shift of the moving image area in the right and left directions in the screen but also the shift of the moving image area in the upper and lower directions in the screen. In addition, also according to the shift of moving image areas 51, 52 and 53 in the screen, the luminance of the light source can be kept at the reference value.

In the present exemplary embodiment, whether or not the above-mentioned control is carried out can be judged based on the movement amount of the entire frame. For example, PWM control section 15 cumulatively adds the numbers included in the frame of the scanning lines outputting the scanning line movement determination signal over one vertical cycle period based on the movement amount for every scanning line by moving picture detecting section 12. Thus, it is possible to calculate the movement amount of the entire frame. At this time, the value of the scanning line cumulatively added over one vertical cycle period is compared with predetermined upper threshold value and lower threshold value, and when the value is in the range between the both threshold values, turning-off control is carried out according to the addressing start position of the moving picture. When the value is less than the lower-limit threshold value, the image is determined to be a still image and the turning-off control is not carried out. Meanwhile, when the value is more than the upper-limit threshold value, the turning-off control is not carried out because the period for addressing a moving picture exceeds the predetermined basic turning-off period and a desired luminance cannot be obtained. That is to say, PWM control section 15 specifies a moving image area based on the number of the scanning line included in the frame outputting a scanning line movement determination signal, that is, a signal showing that a moving image is included in the scanning line period among the scanning line movement determination signals output in the frame. Then, PWM control section 15 specifies a moving image area when the number of the scanning lines included in the frame outputting a scanning line movement determination signal, that is, a signal showing that a moving picture is included in the scanning line period among the scanning line movement determination signals output for a scanning line period is not less than the lower-limit threshold value and not more than the upper-limit threshold value. Then, an operation is carried out in a blinking mode. Furthermore, PWM control section 15 does not specify a moving image area and controls PWM pulse generating section 16 to be operated in a normal image mode when the number included in the frame of the scanning lines outputting a scanning line movement determination signal, that is, a signal showing that a moving picture is included in a scanning line period among the scanning line movement determination signals output for a frame is less than the lower-limit threshold value or more than the upper-limit threshold value.

Furthermore, in addition to the basic operation as mentioned above, an operation is carried out so that the turning-off period of light source 11 is increased according to the reference value of the luminance of the light source when the luminance of the light source is set to be low based on the detection result of characteristic amount detecting section 13.

Thus, a period for inserting black is increased with the extension of the turning-off period, so that display can be further approached to impulse type display. Furthermore, since the turning-off period is increased and the size of a moving picture that can be addressed during the period is increased, the size range of the moving picture that undergoes turning-off control can be increased. Thus, the turning-off period can be expanded to its maximum according to the brightness of the input picture signal, the size of an applicable moving picture can be expanded, and an effect of improving the response of display moving picture can be enhanced.

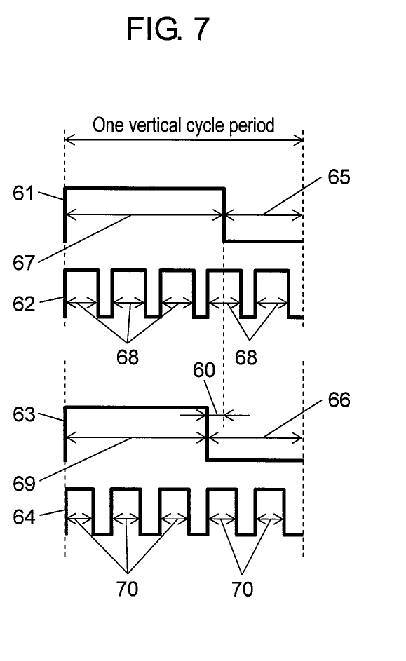

Next, PWM control waveforms according to the presence or absence of a moving image in a screen are described with reference to FIG. 7. Firstly, based on the average luminance value detected by characteristic amount detecting section 13, a case where the luminance of the light source is not controlled is described. In this case, PWM control section 15 controls PWM pulse generating section 16 so that the luminance of the light source is made to be equal in the blinking mode and the normal image mode.

Waveform 61 in FIG. 7 shows a PWM control waveform in one vertical cycle period when it is determined that a moving image is included in the screen. Furthermore, waveform 62 shows a PWM control waveform in one vertical cycle period when it is determined that a moving image does not exist. As shown in waveform 61 in FIG. 7, when a turning-off processing of light source 11 is carried out in the moving image area, light source 11 is turned off in a part of turning-off period 65 in one vertical cycle period, and turned on in turning-on period 67 so as to make display into an impulse type. This is a blinking mode.

On the other hand, as shown in waveform 62 of FIG. 7, when it is determined that a still image exists (a moving image is not included) and when it is determined that a moving image is included but is beyond the range to be handled, in order to prevent flicker, controlling is carried out with a frequency of multiplication of vertical frequency. This waveform shows a normal image mode. At this time, the turning-on period or the turning-off period of light source 11 is controlled so that the integral luminance of a moving image area is allowed to coincide with that of a still picture and image area. Specifically, PWM control section 15 controls so as to allow the total of turning-on periods 68 shown in waveform 62 to coincide with turning-on period 67 shown in waveform 61. That is to say, PWM control section 15 controls PWM pulse generating section 16 so that the luminance of the light source is made to be equal in the blinking mode and the normal image mode. Note here that the control operation of PWM control section 15 when the screen states are being changed from each other between in the blinking mode and in the normal image mode is described later.

Next, a case in which PWM control section 15 controls PWM pulse generating section 16 so that the luminance of the light source is made to be the reference value based on the average luminance value detected by characteristic amount detecting section 13 is described. Also in this case, PWM control section 15 controls PWM pulse generating section 16 so that the luminance of the light source is made to be equal between in the blinking mode and in the normal image mode.

Waveforms 63 and 64 of FIG. 7 are described. Waveform 63 shows a case in which turning-off period 66 including a moving image area is increased based on the reference value of the luminance of the light source. That is to say, turning-off period 66 is increased by a portion of turning-off period 60 as compared with turning-off period 65 of waveform 61. Waveform 63 is in a blinking mode. Note here that turning-off period 60 may be, for example, 10% of one vertical cycle. However, it is not necessarily limited to this value.

On the other hand, as shown in waveform 64 of FIG. 7, when it is determined that a still image exists (a moving image is not included) and when it is determined that a moving image is included but is beyond the range to be handled, in order to prevent flicker, controlling is carried out with a frequency of multiplication of vertical frequency. This waveform shows a normal image mode. In this way, the turning-on period or the turning-off period of light source 11 is controlled so that the integral luminance of a moving image area and an area continuing to the moving area is allowed to coincide with that of a still picture and an image area. Specifically, PWM control section 15 controls so as to allow the total of turning-on periods 70 shown in waveform 64 to coincide with turning-on period 69 shown in waveform 63. That is to say, also in a case of increasing turning-on period 66 including a moving picture area, PWM control section 15 controls PWM pulse generating section 16 so that the luminance of the light source is made to be equal in the blinking mode and the normal image mode.

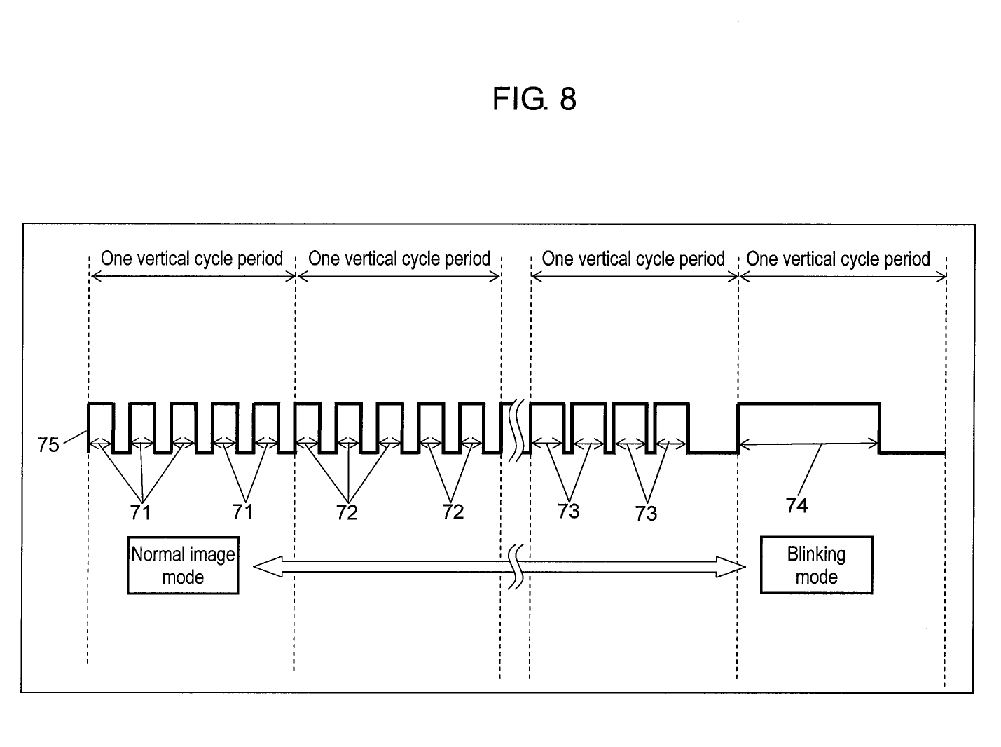

Next, the control operation by PWM control section 15 when the screen state is changed in the case where it is determined that a still image exists (operation in a normal image mode) and in the case where it is determined that a moving image is included (operation in a blinking mode) are described with reference to FIG. 8. FIG. 8 shows waveform 75 of PWM pulse generating section 16 when an operation is switched from a frame at the left end in which it is determined that a still image exists toward a frame at the right end in which it is determined that a moving image is included or when an operation is switched in the direction opposite to the above-mentioned direction.

In a frame at the left end, as mentioned above, the ratio of turning-on period 71 or turning-off period of light source 11 is determined so that a luminance of the light source becomes the reference value based on the average luminance value detected by characteristic amount detecting section 13. Next, the ratio of turning-on and turning-off is gradually changed toward the operation in a blinking mode. Then, the moving image area is turned off. Furthermore, while the ratio of turning-on and turning-off is gradually changed, turning-off is carried out by gradually including a moving image area and an area continuing to this moving image area. Then, in a frame at the right end, an operation is carried out in a blinking mode. Turning-on period 74 is equal to other turning-on periods 71, 72 and 73. That is to say, as shown in the drawing, the ratio of turning-on period or turning-off period of light source 11 in each frame is controlled to be constant. When the ratio of turning-on and turning-off is changed, the changed amount of the ratio for every frame is made to be constant. Furthermore, when an operation is switched to that in the opposite direction, the procedure opposite to the above-mentioned procedure is employed. That is to say, PWM control section 15 controls PWM pulse generating section 16 so that the luminance of the light source is made to be equal for every frame when the blinking mode and the normal image mode are switched from each other.

With such a control, a picture display device in the present exemplary embodiment permits switching between the normal image mode and the blinking mode with the luminance of the light source kept at the reference value.

As mentioned above, the picture display device in the present exemplary embodiment includes picture display section 10 for projecting a picture signal that has been input; light source 11 for visualizing a picture in picture display section 10; moving image detecting section 12 for outputting a scanning line movement determination signal for every scanning line based on the movement amount for every scanning line of the picture signal; light source luminance setting section 14 for determining the reference value of the luminance of the light source; PWM pulse generating section 16 for controlling flashing of light source 11; PWM control section 15 for outputting a moving image specifying signal that specifies a moving image area included in a frame based on the scanning line movement determination signal so as to control PWM pulse generating section 16. PWM control section 15 controls PWM pulse generating section 16 in a blinking mode by turning off light source 11 in a period for scanning a moving image area including a scanning line having the largest movement amount.

Furthermore, the picture display device in the present exemplary embodiment can improve the quality of the moving picture by allowing display to approach to an impulse type display by turning off the light source so as to allow the data addressing period to be not displayed for a predetermined period from a start scanning line in which a panel scans the detected moving image. Furthermore, it is possible to realize a picture display device in which the size of the applicable moving image is expanded according to the brightness of the input picture signal and an effect of improving the response of display moving picture can be enhanced.

In the present exemplary embodiment, moving picture detecting section 12 is assumed to output a scanning line movement determination signal based on only the movement amount for every scanning line of the input picture signal. However, moving picture detecting section 12 may detect a moving picture such as character information having particularly high luminance. A moving image area including such a moving picture may be updated by further increasing the weight of the movement amount.

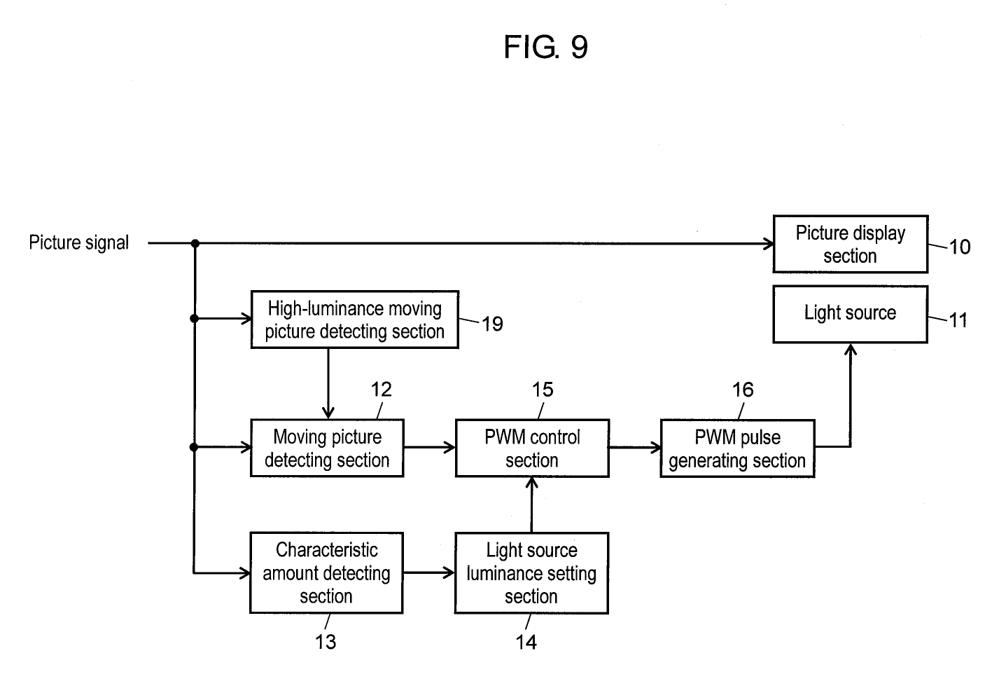

FIG. 9 is a block diagram showing a configuration of a picture display device in accordance with a further example of the first exemplary embodiment. The picture display device of the further example is different from that of the other example in the present exemplary embodiment in that it includes high-luminance moving picture detecting section 19 for detecting a high-luminance moving picture and outputting a high-luminance moving picture determination signal to moving picture detecting section 12. Since the picture display device of the further example has the same configuration and operation as those in the picture display device of the other example in accordance with the present exemplary embodiment except that high-luminance moving picture detecting section 19 is further provided, detailed description is omitted.

Hereinafter, an operation of the thus configured picture display device of the further example is described. As shown in FIG. 4, the value “0” or “1” is assigned to the high-luminance moving image determination signal. When high-luminance moving picture detecting section 19 detects a high luminance moving picture, the high-luminance moving image determination signal is “1.” When high-luminance moving picture detecting section 19 does not detect a high luminance moving picture, the high-luminance moving image determination signal is “0.”

High-luminance moving picture detecting section 19 detects a moving picture having high luminance such as character information included in the screen. Furthermore, the detection condition may include a high edge density. The edge density is detected as follows. That is to say, the input picture signal is allowed to pass through a high-pass filter and an edge included in the N-th scanning line (N corresponds to an arbitrary position in the frame) of the frame constituting the picture signal is detected. When luminance is high and an edge has a higher density than the predetermined density threshold value, high-luminance moving picture detecting section 19 may output a high-luminance moving picture determination signal. Note here that the predetermined density threshold value may be defined as, for example, a case in which an edge is closely present in an interval of 10 dots or less. However, the predetermined density threshold value is just an example and is not limited to this value. For example, it may be appropriately changed according to the resolution of picture display section 10.

Then, moving picture detecting section 12 updates the movement amount by calculating the movement amount with a predetermined multiple based on the high-luminance moving picture determination signal. Note here that the predetermined multiple may be, for example, an integer from about 2 to 7. As a result, when the high-luminance moving picture determination signal is output, weighting of the movement amount is increased and its priority can be increased as compared with the other moving image area. Therefore, a moving image area including character information included in the screen may be a moving image area including a scanning line having the largest movement amount. As a result, PWM control section 15 can carry out operation control so that the moving image area including character information is preferentially turned off in a blinking mode operation time.

### Second Exemplary Embodiment

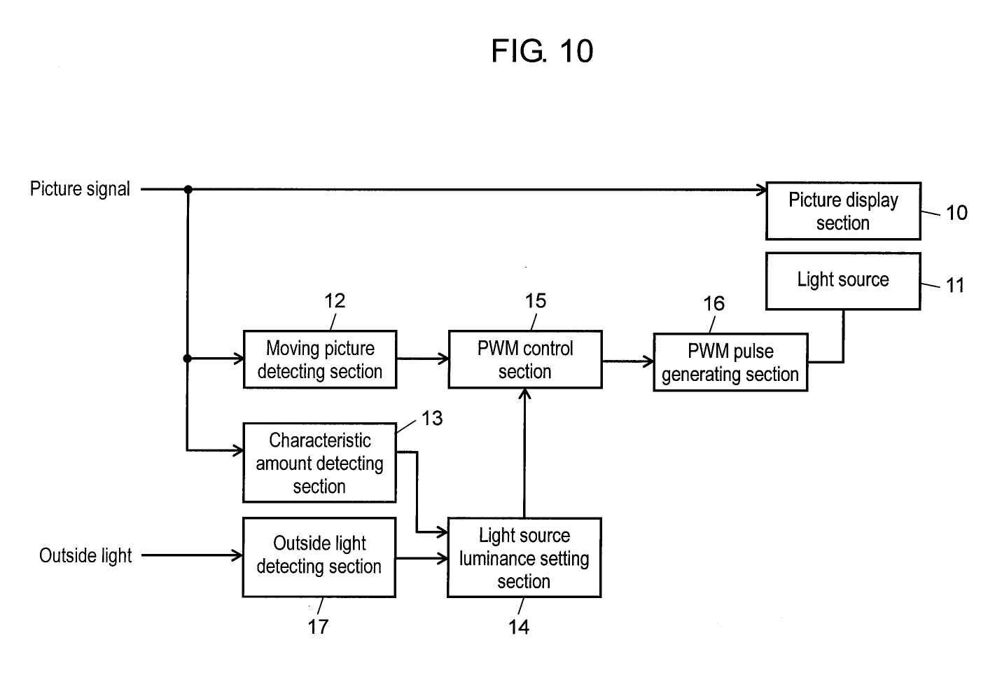

FIG. 10 is a block diagram showing a configuration of a picture display device in accordance with a second exemplary embodiment of the present invention. The picture display device in accordance with the second exemplary embodiment is different from the picture display device of the other example shown in FIG. 5 in accordance with the first exemplary embodiment in that it further includes outside light detecting section 17 for detecting the ambient brightness and outputting an outside light detection signal. Outside light detecting section 17 inputs the outside light detection signal based on the ambient brightness into light source luminance setting section 14. Furthermore, light source luminance setting section 14 is characterized by changing the reference value of the luminance of the light source based on the outside light detecting signal. Since the other points are the same as in the block diagram of FIG. 5, the same reference numerals are given to the same parts and detailed description is omitted herein.

Next, an operation of the thus configured picture display device is described. Outside light detecting section 17 detects the ambient brightness and outputs an outside light detecting signal. Light source luminance setting section 14 receives an input of the outside light detecting signal and changes the reference value of the luminance of the light source based on the outside light detecting signal. At this time, specifically, light source luminance setting section 14 sets the luminance of the light source to be high when the outside light is bright according to the output from outside light detecting section 17. Furthermore, light source luminance setting section 14 sets the luminance of the light source to be low when the outside light is dark. Furthermore, light source luminance setting section 14 may be controlled so that the brightness by the outside light and the brightness on the screen of picture display section 10 based on the luminance of the light source to be substantially equal to each other.

With such a configuration, the picture display device in the present exemplary embodiment can improve the quality of the moving picture by allowing display to approach to an impulse type display by turning off the light source so as to allow the data addressing period to be not displayed for a predetermined period from a start scanning line in which a panel scans the detected moving image. Furthermore, it is possible to realize a picture display device in which the size of the applicable moving image is expanded according to the brightness of the surrounding environment of the picture display device and an effect of improving the response of display moving picture can be enhanced.

### Third Exemplary Embodiment

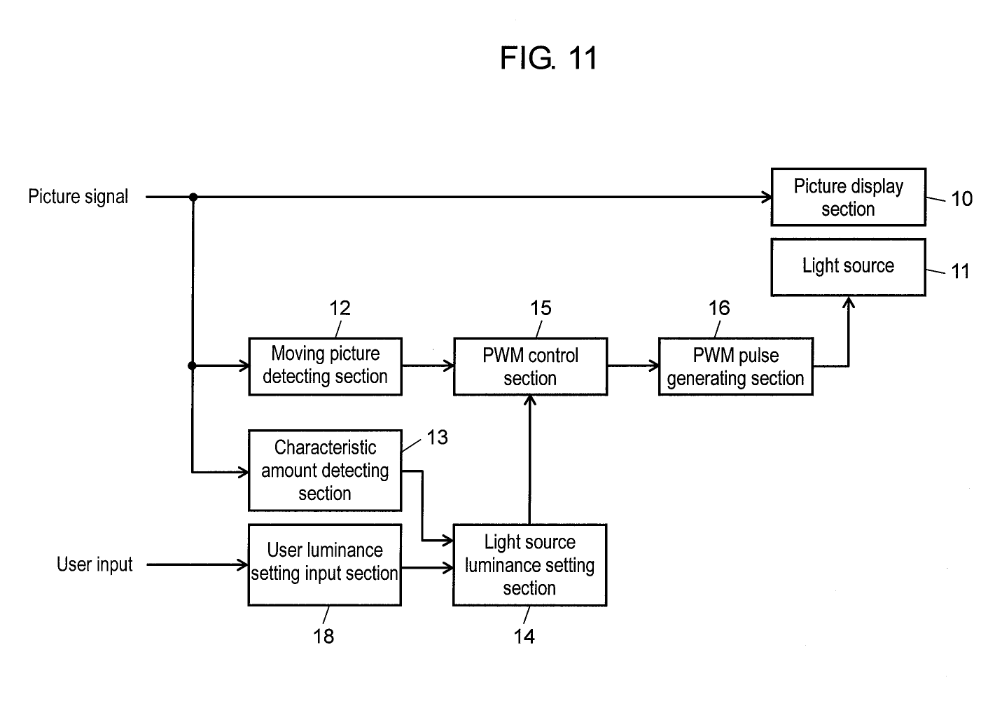

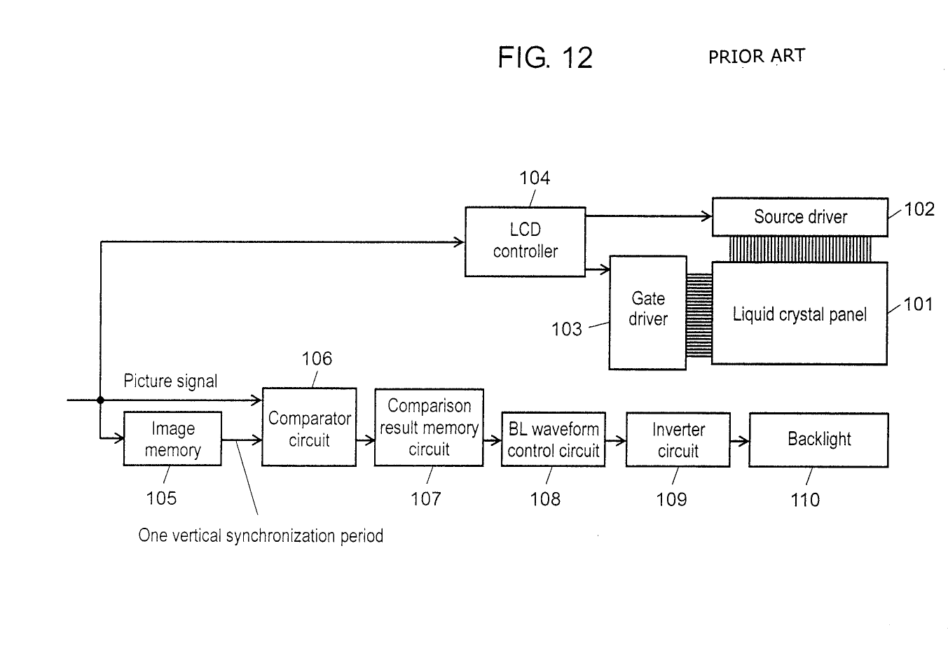

FIG. 11 is a block diagram showing a configuration of a picture display device in accordance with a third exemplary embodiment. The picture display device in accordance with the third exemplary embodiment is different from the picture display device of the other example shown in FIG. 5 in accordance with the first exemplary embodiment in that it further includes user luminance setting input section 18 for receiving the setting of luminance of the light source from a user and outputting a user luminance setting signal. Since the other points are the same as in the block diagram shown in FIG. 5, the same reference numerals are given to the same parts and detailed description is omitted herein.

Next, an operation of the thus configured picture display device is described. User luminance setting input section 18 inputs a user luminance setting signal into light source luminance setting section 14. Then, light source luminance setting section 14 changes the reference value of the luminance of the light source based on the user luminance setting signal. At this time, specifically, light source luminance setting section 14 reduces the reference value of the luminance of the light source to half or quarter thereof based on the user luminance setting signal. Furthermore, light source luminance setting section 14 increases the reference value of the luminance of light source to twice or four times thereof based on the user luminance setting signal.

With such a configuration, the picture display device in the present exemplary embodiment can improve the quality of the moving picture by allowing display to approach to an impulse type display by turning off the light source so as to allow the data addressing period to be not displayed for a predetermined period from a start scanning line in which a panel scans the detected moving image. Furthermore, it is possible to realize a picture display device in which the size of the applicable moving image is expanded according to the brightness of the input picture signal and an effect of improving the response of display moving picture can be enhanced.

### INDUSTRIAL APPLICABILITY

A picture display device in accordance with the present invention can improve the quality of a moving picture by allowing display to approach to an impulse type display by turning off a light source in a predetermined period from a start scanning line in which a panel scans the detected moving image so as to make the data addressing period be not displayed. The picture display device is useful in a picture display device such as a liquid crystal television having a backlight or a projector having a light source.

1. A picture display device comprising:
a picture display section for projecting an input picture signal;
a light source for visualizing a picture in the picture display section;
a moving picture detecting section for outputting a scanning line movement determination signal for every scanning line based on a movement amount of a picture signal for the every scanning line;
a PWM pulse generating section for controlling flashing of the light source; and
a PWM control section for outputting a moving image specifying signal that specifies a moving image area included in a frame based on the scanning line movement determination signal, to control the PWM pulse generating section;
wherein the PWM control section controls the PWM pulse generating section in a blinking mode by turning off the light source in a period for scanning the moving image area including a scanning line having a largest movement amount.

2. The picture display device of claim 1, further comprising:
a characteristic amount detecting section for detecting an average value of luminance of the picture signal; and
a light source luminance setting section for determining a reference value of the luminance of the light source;
wherein the light source luminance setting section determines the reference value of the luminance of the light source based on the average value of luminance detected by the characteristic amount detecting section; and
the PWM control section controls the PWM pulse generating section so that the luminance of the light source becomes the reference value by further turning off the light source in a period for scanning an area that continues to the moving image area including the scanning line having a largest movement amount.

3. The picture display device of claim 1, further comprising:
a high-luminance moving picture detecting section for detecting a moving picture having a high luminance and outputting a high-luminance moving picture determination signal to the moving picture detecting section; and
the high-luminance moving picture detecting section updates the movement amount by calculating the movement amount with a predetermined multiple based on the high-luminance moving picture determination signal.

4. The picture display device of claim 1,
wherein the moving picture detecting section outputs the scanning line movement determination signal when the movement amount of the picture signal in the scanning line period is not less than a lower-limit movement determination threshold value and not more than an upper-limit movement determination threshold value.

5. The picture display device of claim 1,
wherein the PWM control section specifies the moving image area based on a number of the scanning line, included in the frame, outputting the scanning line movement determination signal that is a signal showing that a moving picture is included in the scanning line period among the scanning line movement determination signals output in the frame.

6. The picture display device of claim 5,
wherein the PWM control section specifies the moving image area when the number is not less than a lower-limit threshold value and not more than an upper-limit threshold value.

7. The picture display device of claim 2,
wherein the PWM control section controls the PWM pulse generating section so that luminance of the light source for every frame is made to be equal to each other when a blinking mode and a normal image mode are switched from each other.

8. The picture display device of claim 2, further comprising:
an outside light detecting section for detecting ambient brightness and outputting an outside light detecting signal,
wherein the outside light detecting section inputs the outside light detecting signal based on the ambient brightness into the light source luminance setting section; and
the light source luminance setting section changes the reference value of the light source luminance based on the outside light detecting signal.

9. The picture display device of claim 2, further comprising:
a user luminance setting input section for receiving a setting of luminance of the light source from a user and outputting a user luminance setting signal,
wherein the user luminance setting input section inputs the user luminance setting signal into the light source luminance setting section; and
the light source luminance setting section changes the reference value of the luminance of the light source based on the user luminance setting signal.

10. The picture display device of claim 4,
wherein the moving picture detecting section does not specify the moving image area when the movement amount for every scanning line is less than a lower-limit threshold value or more than an upper-limit threshold value.

11. The picture display device of claim 5,
wherein the PWM control section does not specify the moving image area when the number is less than a lower-limit threshold value or more than an upper-limit threshold value.
